(19) United States
(12) Patent Application Publication
(10) Pub. No.: US 2025/0044521 A1
(43) Pub. Date: Feb. 6, 2025

(54) OPTICAL DEVICE, WAFER, AND OPTICAL TRANSCEIVER

(71) Applicant: FUJITSU OPTICAL COMPONENTS LIMITED, Kawasaki-shi (JP)

(72) Inventor: Masaki SUGIYAMA, Kawasaki (JP)

(73) Assignee: FUJITSU OPTICAL COMPONENTS LIMITED, Kawasaki-shi (JP)

(21) Appl. No.: 18/746,490

(22) Filed: Jun. 18, 2024

(30) Foreign Application Priority Data
Jul. 31, 2023 (JP) 2023-124913

(51) Int. Cl. G02B 6/35

(52) U.S. Cl. CPC G02B 6/355; G02B 6/3546

(57) ABSTRACT

An optical device is an optical device that is formed on a wafer. The optical device includes an optical circuit, a grating coupler, and an optical switch that includes a first port that is connected to the grating coupler, a second port that is connected to the optical circuit, and a third port that is connected to a loop mirror by way of a phase shifter.

### CROSS-REFERENCE TO RELATED APPLICATION

This application is based upon and claims the benefit of priority of the prior Japanese Patent Application No. 2023-124913, filed on Jul. 31, 2023, the entire contents of which are incorporated herein by reference.

### FIELD

The embodiments discussed herein are related to an optical device, a wafer, and an optical transceiver.

### BACKGROUND

FIG. 9 is an explanation diagram illustrating one example a test system 200 that is conventionally used. The test system 200 illustrated in FIG. 9 includes a test device 210, an optical chip 220, and an optical fiber 230. The test device 210 includes a light source 211, a polarization controller 212, a circulator 213, and a power meter 214.

The light source 211 is a light source that emits, for example, test light corresponding to reception light, local emission light, or transmission light. The polarization controller 212 polarizes the test light received from the light source 211, and outputs the polarized test light to the circulator 213. Furthermore, the polarization controller 212 performs polarization control of the test light, and generates test light with TM polarization or TE polarization. The circulator 213 outputs the test light that is incident from the polarization controller 212 to the optical fiber 230, and outputs the reflected return light with respect to the test light that is incident from the optical fiber 230 to the power meter 214. The power meter 214 receives the reflected return light with respect to the test light, which has been received from an optical circuit 222, from the circulator 213, and measures power of the reflected return light.

The optical chip 220 is, for example, an optical IC chip, such as a digital coherent optical transmitter/receiver. The optical chip 220 is the optical chip that has been cut out from a wafer. The optical chip 220 includes an optical port 221, the optical circuit 222, and an optical waveguide 223. As a result of chipping the wafer, the optical port 221 accordingly appears at an end portion 224 of the side surface of the optical chip 220. The optical waveguide 223 is a waveguide through which light is guided between the optical port 221 and the optical circuit 222. The optical circuit 222 is a circuit of, for example, an optical transmitter, an optical receiver, and the like provided in a digital coherent optical transmitter/receiver.

In a conventional test method of testing the optical chip 220, the optical chip 220 is cut out from the wafer, and each of the cut out optical chips 220 is placed on a stage. Furthermore, a portion between an output side of the circulator 213 included in the test device 210 and the optical port 221 that is disposed at the end portion 224 of the side surface of the optical chip 220 is connected by the optical fiber 230. Then, the test device 210 measures the power of the reflected return light with respect to the test light by using the power meter 214, and evaluates the optical chip 220 on the basis of the measurement result.

However, in the conventional test method of testing the optical chip 220, alignment work for aligning the optical axes of the optical port 221 and the optical fiber 230 is needed for each of the optical chips 220. Consequently, work load at the time of measurement of the power of the reflected return light with respect to the test light performed by optically connecting the optical chip 220 and the test device 210 is increased.

Furthermore, it is conceivable that working efficiency is increased in the case where a test is able to be carried out in a wafer state before chipping the optical chip 220, but, if a test is carried out in the wafer state, there is a need to input light from a direction of a wafer surface by using the optical fiber. Accordingly, a test system 100 that uses this sort of test method will be described.

FIG. 8 is an explanation diagram illustrating one example of the test system 100 that is conventionally used. The test system 100 includes a wafer made of, for example, silicon or the like on which a plurality of optical chips 110 are formed, the test device 210, and the optical fiber 230. Moreover, by assigning the same reference numerals to components having the same configuration as those in the test device 210 illustrated in FIG. 9, overlapped descriptions of the configuration and the operation thereof will be omitted.

On the wafer, the plurality of optical chips 110 are formed in a grid arrayed state. The optical chip 110 includes an optical circuit chip 110A, a test circuit chip 110B, and a dicing line 110C that is able to be cut between the optical circuit chip 110A and the test circuit chip 110B. The optical circuit chip 110A includes an optical port 111A, an optical circuit 112A, and a first optical waveguide 113A that optically couples the optical port 111A and the optical circuit 112A. As a result of chipping the wafer, the optical port 111A accordingly appears at the end portion 224 of the side surface of the optical chip 220. The optical circuit 112A is a circuit of, for example, an optical transmitter, an optical receiver, and the like provided in a digital coherent optical transmitter/receiver. The first optical waveguide 113A is a waveguide through which light is guided between the optical port 111A and the optical circuit 112A.

The test circuit chip 110B includes a grating coupler (GC) 111B and a second optical waveguide 112B. The GC 111B is arranged on the surface of the test circuit chip 110B, is detachably connected to the optical fiber 230, and is connected to the second optical waveguide 112B. The second optical waveguide 112B is optically connected to the optical port 111A that is included in the optical circuit chip 110A.

The test device 210 includes the light source 211, the polarization controller 212, the circulator 213, and the power meter 214.

In the following, an operation of the test system 100 will be described. The polarization controller 212 included in the test device 210 polarizes the test light received from the light source 211, and outputs the polarized test light to the circulator 213. The circulator 213 outputs the polarized test light to the optical fiber 230. The GC 111B disposed on the test circuit chip 110B inputs the test light received from the optical fiber 230 to the second optical waveguide 112B. Furthermore, the optical circuit chip 110A receives the test light from the optical port 111A that is connected to the second optical waveguide 112B, and inputs the incident test light to the first optical waveguide 113A.

The first optical waveguide 113A inputs the test light to the optical circuit 112A. The optical circuit 112A outputs the reflected return light with respect to the test light to the first optical waveguide 113A. The first optical waveguide 113A outputs the reflected return light to the second optical waveguide 112B through the optical port 111A. The second optical waveguide 112B outputs the reflected return light received from the first optical waveguide 113A to the optical fiber 230 by way of the GC 111B. Furthermore, the circulator 213 outputs the reflected return light received from the optical fiber 230 to the power meter 214.

The power meter 214 measures the power of the reflected return light with respect to the test light received from the circulator 213. In the test system 100, it is possible to make light to be incident by approaching the optical fiber 230 to the GC 111B from the direction of the wafer surface and input the test light to the optical circuit 112A, so that the test is available in the wafer state. The test device 210 evaluates the optical circuit chip 110A on the basis of the measurement result of the reflected return light received from the optical circuit 112A.
Patent Document 1: U.S. Patent Application Publication No. 2022/0065743
Patent Document 2: Japanese Laid-open Patent Publication No. 2020-181076
Patent Document 3: Japanese Laid-open Patent Publication No. 2020-72345

In the test device 210 included in the test system 100 that is conventionally used, the reflected return light received from the optical circuit 112A is measured. However, in the test device 210, the reflected light with respect to the test light is generated with respect to the GC 111B that is connected to the optical fiber 230, so that the reflected light with respect to the test light received from the GC 111B is accordingly included in a measurement value of the reflected return light. Consequently, it is difficult to obtain the reflected return light received from the optical circuit 112A with high accuracy.

### SUMMARY

According to an aspect of an embodiment, an optical device is formed on a wafer. The optical device includes an optical circuit, a grating coupler and an optical switch. The optical switch includes a first port that is connected to the grating coupler, a second port that is connected to the optical circuit, and a third port that is connected to a loop mirror by way of a phase shifter.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanation diagram illustrating one example of a test system according to a first embodiment;

FIG. 2 is a plan view illustrating one example of a wafer on which optical chips are formed;

FIG. 3 is an explanation diagram illustrating one example of a test system according to a second embodiment;

FIG. 4 is an explanation diagram illustrating one example of a test system according to a third embodiment;

FIG. 5 is an explanation diagram illustrating one example of a test system according to a fourth embodiment;

FIG. 6 is an explanation diagram illustrating one example of a test system according to a fifth embodiment;

FIG. 7 is an explanation diagram illustrating one example of an optical transceiver including an optical chip;

FIG. 8 is an explanation diagram illustrating one example of a test system that is conventionally used; and

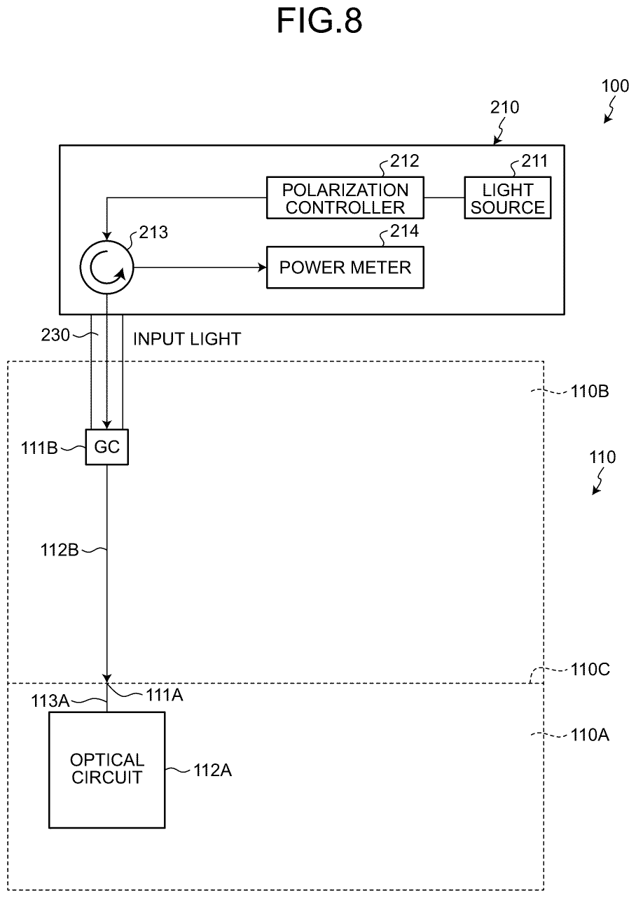

FIG. 9 is an explanation diagram illustrating one example of a test system that is conventionally used.

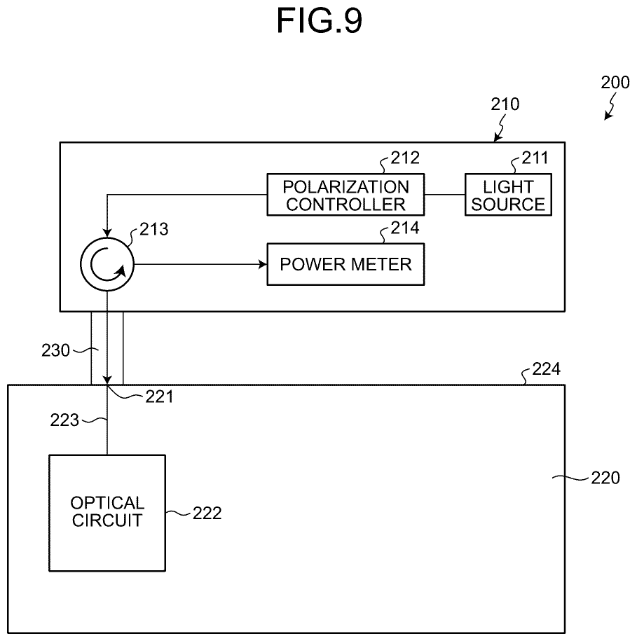

### DESCRIPTION OF EMBODIMENTS

Preferred embodiments of the present invention will be explained with reference to accompanying drawings. Furthermore, the disclosed technology is not limited to the embodiments. In addition, each of the embodiments can be used in any appropriate combination as long as they do not conflict with each other.

### (a) First Embodiment

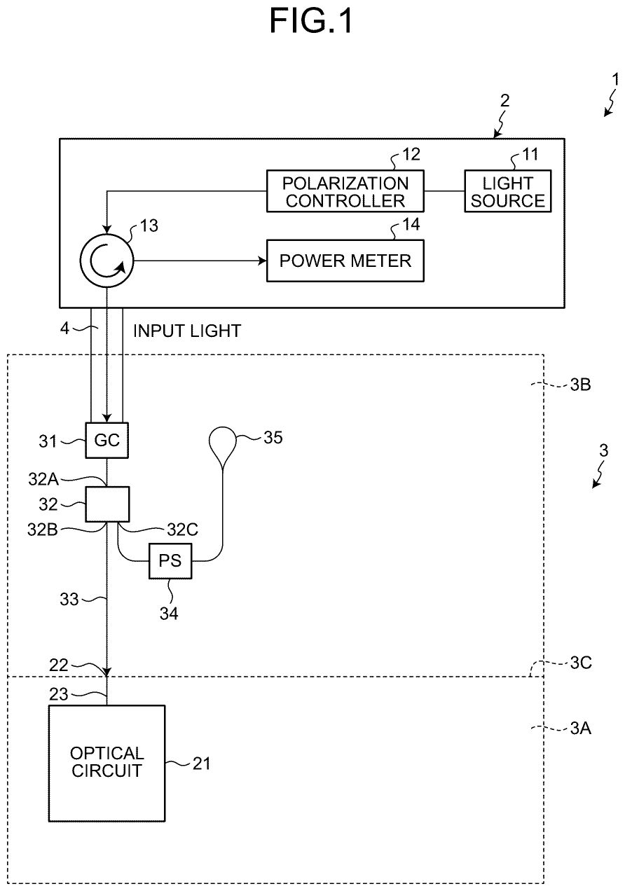

FIG. 1 is an explanation diagram illustrating one example of a test system 1 according to a first embodiment. The test system 1 illustrated in FIG. 1 includes an optical chip 3, a test device 2, an optical fiber 4 that optically connects the optical chip 3 and the test device 2. The optical chip 3 is, for example, an optical IC chip including an optical circuit, such as a digital coherent optical transmitter/receiver. The test device 2 is an evaluation device that evaluates the optical chip 3.

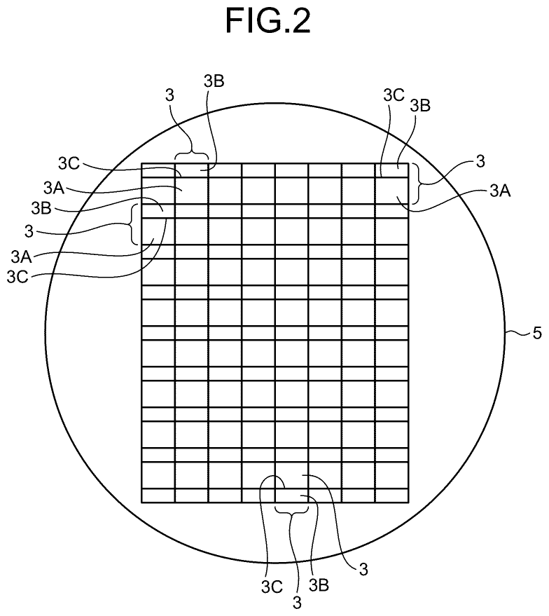

FIG. 2 is a plan view illustrating one example of a wafer 5 on which the optical chips 3 are formed. The wafer 5 illustrated in FIG. 2 is, for example, a silicon wafer. On the wafer 5, the plurality of optical chips 3 are formed in a grid arrayed state. The optical chip 3 is an optical device that includes an optical circuit chip 3A, a test circuit chip 3B, and a dicing line 3C that is able to be cut between the optical circuit chip 3A and the test circuit chip 3B.

The optical circuit chip 3A includes an optical port 22, an optical circuit 21, and a first optical waveguide 23 that optically connects the optical port 22 and the optical circuit 21. As a result of chipping the wafer 5, the optical port 22 accordingly appears at the end portion of the side surface of the optical circuit chip 3A. The optical circuit 21 is a circuit of, for example, an optical transmitter, an optical receiver, and the like provided in a digital coherent optical transmitter/receiver. The first optical waveguide 23 is a waveguide through which light is guided between the optical port 22 and the optical circuit 21.

The test circuit chip 3B includes a grating coupler (GC) 31, an optical switch 32, a second optical waveguide 33, a phase shifter (PS) 34, and a loop mirror 35. The GC 31 is arranged on the surface of the test circuit chip 3B, is detachably connected to the optical fiber 4 that is connected to the test device 2, and is connected to the optical switch 32. The optical switch 32 is configured by a 1×2 optical switch having a single input port and two output ports. The optical switch 32 includes a first port 32A that is connected to the GC 31, a second port 32B that is connected to the second optical waveguide 33, and a third port 32C that is connected to the PS 34. The optical switch 32 branches the test light received from the GC 31 and outputs the branched test light to the second port that is connected to the second optical waveguide 33 and a third port that is connected to the PS 34. The second optical waveguide 33 is an optical waveguide that is optically connected to the optical port 22 of the optical circuit chip 3A. Moreover, in the optical switch 32, a branching ratio between the second port 32B and the third port 32C is set such that test light at the same level as the reflected light with respect to the test light received from the GC 31 is able to be obtained from the third port 32C.

The role of the PS 34 is to generate, in order to cancel out the reflected light with respect to the test light received from the GC 31, the return light of the test light received from the third port 32C as cancelling light having an opposite phase. The PS 34 changes the phase of the test light received from the third port 32C included in the optical switch 32 by 180 degrees in a direction in which the reflected light with respect to the test light received from the GC 31 is canceled out. The PS 34 transmits the test light that has been input from the third port 32C and then output the test light to the loop mirror 35. Then, the loop mirror 35 returns the test light that has been input from the PS 34 to the PS 34 by taking an alternative path. Then, the PS 34 changes the phase of the test light that has been input from the loop mirror 35 to an opposite phase of the reflected light, and outputs the test light whose phase has been changed to the third port 32C included in the optical switch 32 as the return light.

The test device 2 includes a light source 11, a polarization controller 12, a circulator 13, and a power meter 14. The light source 11 is a LD that emits the test light. The polarization controller 12 polarizes the test light received from the light source 11, and outputs the polarized test light to the circulator 13. The circulator 13 outputs the polarized test light received from the polarization controller 12 to the optical fiber 4. The circulator 13 obtains the reflected return light that has been input from the second port 32B and that has been received from the optical circuit 21, and then outputs the reflected return light to the power meter 14. The reflected return light with respect to the test light is the reflected return light with respect to the test light received from the optical circuit 21. The power meter 14 measures the power of the reflected return light received from the circulator 13. The test device 2 evaluates the optical circuit chip 3A on the basis of the measurement result of the reflected return light measured by the power meter 14.

The optical switch 32 outputs both the return light that has been input from the third port 32C and the reflected return light with respect to the test light that has been input from the second port 32B and that has been received from the optical circuit 21 to the circulator 13 included in the test device 2 by way of the GC 31 and the optical fiber 4. The circulator 13 is able to obtain, with high accuracy, the reflected return light that has been input from the second port 32B and that has been received from the optical circuit 21 by cancelling out the reflected light of the test light received from the GC 31 and the return light that has been input from the third port 32C each other. Then, the circulator 13 outputs the reflected return light to the power meter 14 included in the test device 2.

In the following, an operation of the test system 1 according to the present embodiment will be described. First, the wafer 5 is placed on a wafer prober. Then, as a result of the test circuit chip 3B included in the optical chip 3 on the wafer 5 being moved, a test operation is started while the GC 31 included in the test circuit chip 3B is optically connected to the optical fiber 4.

The polarization controller 12 polarizes the test light received from the light source 11, and inputs the polarized test light to the circulator 13. The circulator 13 outputs the polarized test light to the optical fiber 4. The GC 31 that is connected to the optical fiber 4 outputs the received polarized test light to the optical switch 32. The optical switch 32 inputs the polarized test light received from the first port 32A, and branches and outputs the polarized test light to the second port 32B and the third port 32C.

The optical switch 32 outputs the polarized test light from the second port 32B to the second optical waveguide 33, and outputs the polarized test light to the optical port 22 of the optical circuit chip 3A. The optical circuit chip 3A inputs the polarized test light received from the optical port 22 to the first optical waveguide 23. The optical circuit 21 included in the optical circuit chip 3A inputs the polarized test light received from the first optical waveguide 23, and outputs the reflected return light with respect to the polarized test light to the first optical waveguide 23. The second optical waveguide 33 included in the test circuit chip 3B inputs the reflected return light received from the optical port 22 to the second port 32B included in the optical switch 32.

Furthermore, when the optical switch 32 branches and outputs the polarized test light that has been input from the first port 32A to the second port 32B and the third port 32C, the optical switch 32 outputs the polarized test light from the third port 32C to the PS 34. The PS 34 outputs the test light that has been input from the third port 32C to the loop mirror 35. The loop mirror 35 returns the test light that has been input from the PS 34 to the PS 34 as return light. Then, the PS 34 performs phase adjustment of the return light that has been input from the loop mirror 35, and inputs the return light that has been subjected to the phase adjustment to the third port 32C of the optical switch 32. Moreover, the return light that has been subjected to the phase adjustment is light that cancels out the reflected light with respect to the test light received from the GC 31.

The optical switch 32 multiplexes both the reflected return light that has been input from the second port 32B and the return light that has been input from the third port 32C and that has been subjected to the phase adjustment, and then outputs the reflected return light including the multiplexed return light to the GC 31. Furthermore, in the GC 31, the reflected light with respect to the test light received from the circulator 13 is generated.

Then, as a result of the return reflected light including the return light received from the first port 32A of the optical switch 32 and the reflected light generated from the GC 31 being input to the circulator 13, the circulator 13 outputs only the return reflected light to the power meter 14 by cancelling out the reflected light by the return light. The power meter 14 measures the power of the reflected return light. Moreover, the test device 2 is able to evaluate the optical circuit chip 3A on the basis of the measurement result of the power meter 14.

Then, in the case where the operations of measurement and evaluation of the power of the reflected return light from the optical circuit chip 3A included in all of the optical chips 3 disposed in each row on the wafer 5 illustrated in FIG. 2 have been completed, the test device 2 dices the wafer 5 along the dicing lines 3C of all of the optical chips 3 in each row. Then, the test device 2 starts the measurement operation of measuring the reflected return light for each of the optical chips 3 that are disposed in the subsequent row, and continues the dicing process until the completion of the measurement operation performed on all of the optical chips 3 disposed on the wafer 5. Furthermore, by dicing the wafer 5 along the dicing line 3C disposed on each of the optical chips 3, it is possible to divide the optical circuit chip 3A and the test circuit chip 3B that are included in the optical chip 3 into sections, and it is thus possible to obtain the optical circuit chips 3A.

The optical chip 3 includes the optical circuit 21, the GC 31, and the optical switch 32 that includes the first port 32A that is connected to the GC 31, the second port 32B that is connected to the optical circuit 21, and the third port 32C that is connected to the loop mirror 35 by way of the PS 34. In the optical switch 32, the branching ratio between the second port 32B and the third port 32C is set such that the return light at the same level as the reflected light with respect to the test light received from the GC 31 is able to be obtained from the third port 32C. In the PS 34, an amount of the phase shift of the return light transmitting to the third port 32C is set in the direction in which the reflected light received from the GC 31 is cancelled out. In other words, the branching ratio between the optical switch 32 and the amount of phase shift of the PS 34 are adjusted in advance such that the reflected light received from the GC 31 and the return light received from the PS 34 are canceled out each other, so that the test device 2 is able to measure the reflected return light received from the optical circuit 21 with high accuracy while suppressing the reflected light generated in the GC 31. Consequently, by suppressing the reflected light received from the GC 31, it is possible to accurately evaluate the optical circuit chip 3A on the basis of the measurement result of the reflected return light received from the optical circuit 21.

It is possible to improve the working efficiency at the time of measurement of the power of the reflected return light with respect to the test light by optically connecting the optical chip 3 and the test device 2.

Moreover, for convenience of description, a case has been described as an example in which the PS 34 performs phase adjustment on the return light received from the loop mirror 35, and the return light that has been subjected to the phase adjustment is input to the third port 32C of the optical switch 32. However, the example is not limited to this, and, after the PS 34 performs phase adjustment on the test light that has been input from the third port 32C, the PS 34 may output the test light that has been subjected to the phase adjustment to the loop mirror 35, and may output the test light returned from the loop mirror 35 to the PS 34 as return light. Then, the PS 34 may transmit the return light that has been input from the loop mirror 35 and input the return light to the third port 32C, and appropriate modifications are possible.

### (b) Second Embodiment

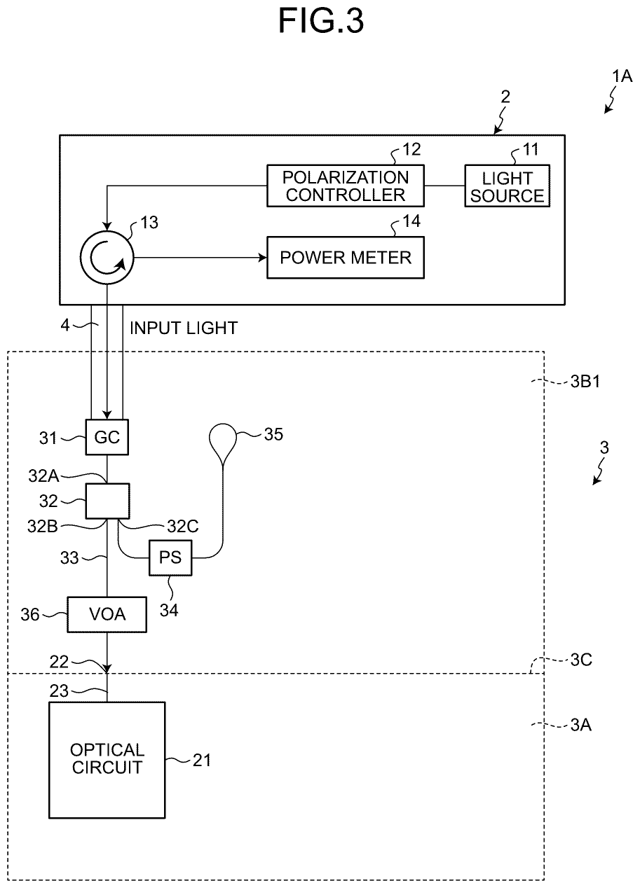

FIG. 3 is an explanation diagram illustrating one example of a test system 1A according to a second embodiment. Moreover, by assigning the same reference numerals to components having the same configuration as those in the test system 1 according to the first embodiment, overlapped descriptions of the configuration and the operation thereof will be omitted. The test system 1A according to the second embodiment is different from the test system 1 according to the first embodiment in that the test system 1A includes a test circuit chip 3B1 in which a variable optical attenuator (VOA) 36 is arranged on the second optical waveguide 33 that is disposed between the first optical waveguide 23 and the optical switch 32.

After the VOA 36 has transmitted the test light transmitting from the second port 32B to the optical circuit 21, the VOA 36 blocks the test light transmitting from the second port 32B to the optical circuit 21. Then, the PS 34 adjusts and sets in advance an amount of phase shift of the test light transmitting to the third port 32C in a direction in which the reflected light that is input to the GC 31 is canceled out while blocking the test light by the VOA 36. Furthermore, the optical switch 32 also adjusts and sets in advance an optical branching ratio between the second port 32B and the third port 32C in a direction in which the reflected light that is input to the GC 31 is canceled out while blocking the test light by the VOA 36.

In the optical switch 32, the branching ratio between the second port 32B and the third port 32C is set such that the return light at the same level as the reflected light received from the GC 31 is able to be obtained while blocking the test light transmitting from the second port 32B to the optical circuit 21 by the VOA 36. In the PS 34, an amount of phase shift of the return light transmitting to the third port 32C is set in a direction in which the reflected light received from the GC 31 is canceled out while blocking the test light transmitting from the second port 32B to the optical circuit 21. Consequently, it is possible to set, with high accuracy, the amount of phase shift to be set in the PS 34 and the branching ratio to be set in the optical switch 32 in terms of cancelling out the reflected light received from the GC 31.

Moreover, a case has been described as an example in which the optical switch 32 included in the test circuit chip 3B in the test system 1 according to the first embodiment is configured by the 1×2 switch. However, the component except for the reflected return light that has been input from the second port 32B and the return light that has been input from the third port 32C corresponds to radiated light. Consequently, this radiated light returns to the optical circuit 21 or the GC 31 and becomes noise, so that the measurement accuracy of the reflected return light is degraded. Accordingly, an embodiment of solving this circumstance will be described below as a third embodiment.

### (c) Third Embodiment

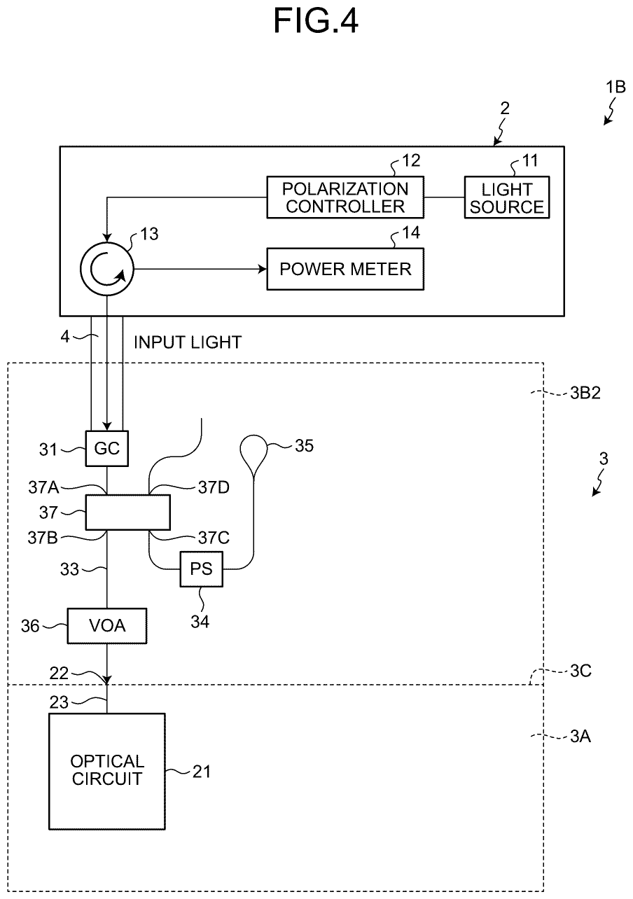

FIG. 4 is an explanation diagram illustrating one example of a test system 1B according to the third embodiment. Moreover, by assigning the same reference numerals to components having the same configuration as those in the test system 1 according to the first embodiment, overlapped descriptions of the configuration and the operation thereof will be omitted. The test system 1 according to the first embodiment is different from the test system 1B according to the third embodiment in that the test system 1B includes a test circuit chip 3B2 in which, instead of the optical switch 32 having a 1×2 configuration, an optical switch 37 having a 2×2 configuration is used.

The optical switch 37 is configured by a 2×2 optical switch having two input ports and two output ports. The input port provided in the optical switch 37 includes a first port 37A that is connected to the GC 31 and a fourth port 37D. The output port provided in the optical switch 37 includes a second port 37B that is connected to the second optical waveguide 33 and a third port 37C that is connected to the PS 34. The optical switch 37 branches and outputs, on the basis of the branching ratio that is set in advance, the test light received from the GC 31 to the second port 37B and the third port 37C. The branching ratio between the second port 37B and the third port 37C is set such that the test light at the same level as the reflected light with respect to the test light received from the GC 31 is able to be obtained from the third port 37C. Furthermore, the branching ratio between the first port 37A and the fourth port 37D included in the optical switch 37 is the same as the branching ratio between the second port 37B and the third port 37C. Furthermore, the optical switch 37 is the 2×2 optical switch, so that the optical switch 37 is able to control the radiated light generated in the 1×2 optical switch 32.

The test circuit chip 3B2 uses the 2×2 optical switch 37, so that it is possible to suppress radiated light from being generated. Consequently, in the test device 2, the measurement accuracy of the reflected return light received from the optical circuit 21 is improved.

### (d) Fourth Embodiment

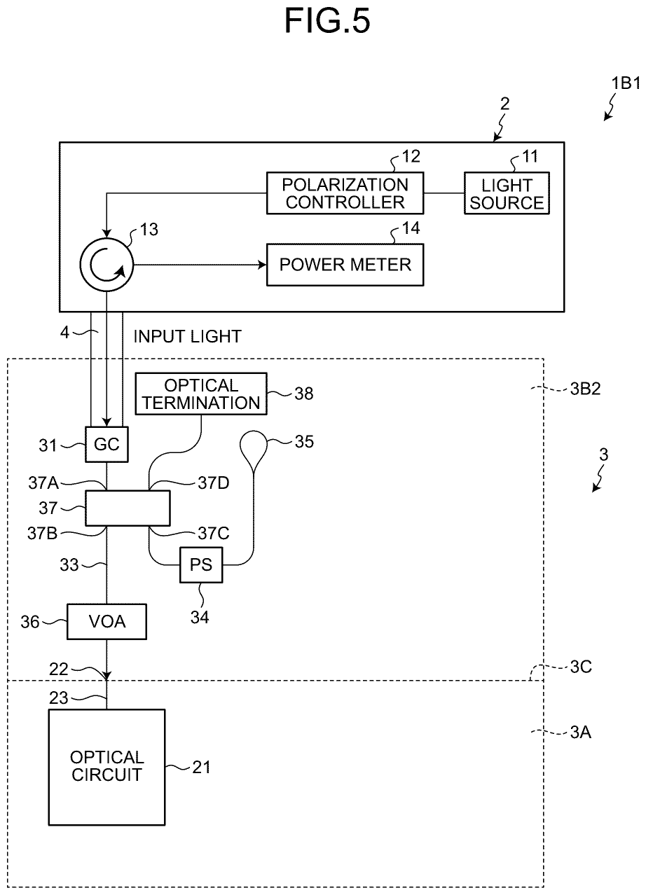

FIG. 5 is an explanation diagram illustrating one example of a test system 1B1 according to a fourth embodiment. Moreover, by assigning the same reference numerals to components having the same configuration as those in the test system 1B according to the third embodiment, overlapped descriptions of the configuration and the operation thereof will be omitted. The test system 1B according to the third embodiment is different from the test system 1B1 according to the fourth embodiment in that an optical termination 38 is optically connected to the fourth port 37D included in the optical switch 37 that has the 2×2 configuration. The optical termination 38 used may be, for example, an optical absorption member that absorbs light. The optical absorption member may be made of, for example, metal, a semiconductor thin film, or metal doped Si.

The optical switch 37 is constituted such that the optical termination 38 is optically connected to the fourth port 37D, the light leaking from the fourth port 37D is absorbed by the optical termination 38. Consequently, in the test device 2, the measurement accuracy of the reflected return light received from the optical circuit 21 is improved.

### (e) Fifth Embodiment

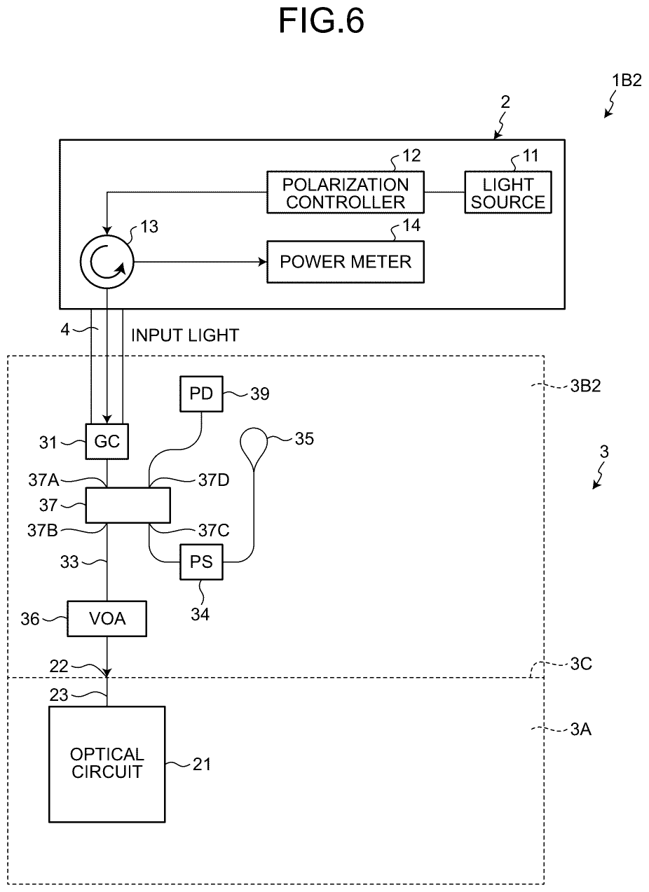

FIG. 6 is an explanation diagram illustrating one example of a test system 1B2 according to a fifth embodiment. Moreover, by assigning the same reference numerals to components having the same configuration as those in the test system 1B1 according to the fourth embodiment, overlapped descriptions of the configuration and the operation thereof will be omitted. The test system 1B1 according to the fourth embodiment is different from the test system 1B2 according to the fifth embodiment in that a photo detector (PD) 39 is used instead of the optical termination 38. The PD 39 is, for example, a photoelectric element that absorbs light. Furthermore, the PD 39 is able to implement high accuracy measurement of reflected return light with high accuracy by connecting an electrical signal that has been subjected to photoelectric conversion by a monitor, monitoring some of reflected return light by the PD 39, and finding a correlation with the value of the power meter 14.

The fourth port 37D is optically connected to the PD 39, so that the light leaking from the fourth port 37D is absorbed by the PD 39. Consequently, in the test device 2, the measurement accuracy of the reflected return light received from the optical circuit 21 is improved.

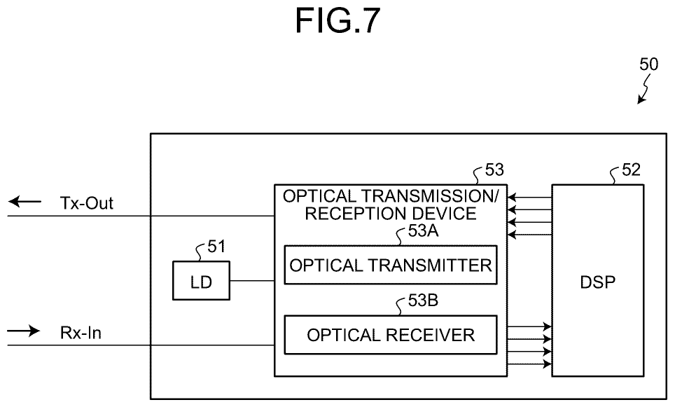

FIG. 7 is an explanation diagram illustrating one example of an optical transceiver 50 including the optical chip 3. The optical transceiver 50 illustrated in FIG. 7 includes a laser diode (LD) 51, a digital signal processor (DSP) 52, and an optical transmission/reception device 53. The LD 51 is a light source that emits light. The optical transmission/reception device 53 is, for example, a digital coherent optical transmitter/receiver. The optical transceiver 50 includes an optical transmitter 53A that transmits signal light and an optical receiver 53B that receives signal light. The optical receiver 53B is, for example, the optical circuit chip 3A, such as a digital coherent receiver, that converts the signal light to an electrical signal and that is obtained after the test circuit chip 3B has been cut out. The DSP 52 performs digital conversion on each of the electrical signals that are input from the optical receiver 53B. The optical transmitter 53A is, for example, the optical circuit chip 3A, such as a digital coherent transmitter, that modulates light in accordance with the electrical signal received from the DSP 52 and that is obtained after the test circuit chip 3B has been cut out.

Moreover, for convenience of description, a case has been described as an example in which the optical fiber 4 is fixed onto a wafer prober and the wafer 5 mounted on the wafer prober is moved up, down, left, and right with respect to the optical fiber 4. However, the optical fiber 4 may be moved up, down, left, and right on the wafer 5, and appropriate modifications are possible.

Furthermore, the digital coherent transmitter/receiver is used as an example of the optical circuit chip 3A, but the example is not limited to a digital coherent technique, and an optical receiver or an optical transmitter constituted by using another technique may be used, and appropriate modifications are possible.

Each of the components in the units illustrated in the drawings is not always physically configured as illustrated in the drawings. In other words, the specific shape of a separate or integrated unit is not limited to the drawings; however, all or part of the unit can be configured by functionally or physically separating or integrating any of the units depending on various kinds of loads or use conditions.

Furthermore, all or any part of various processing functions performed by each unit may also be executed by a central processing unit (CPU) (or, a microcomputer, such as a micro processing unit (MPU) or a micro controller unit (MCU)). In addition, all or any part of various processing functions may also be, of course, executed by programs analyzed and executed by the CPU (or the microcomputer, such as the MPU or the MCU), or executed by hardware by wired logic.

According to an aspect of an embodiment, it is possible to obtain, with high accuracy, reflected return light from an optical circuit with respect to light.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device that is formed on a wafer, the optical device comprising:
an optical circuit;
a grating coupler; and
an optical switch that includes
a first port that is connected to the grating coupler,
a second port that is connected to the optical circuit, and
a third port that is connected to a loop mirror by way of a phase shifter.

2. The optical device according to claim 1, wherein
the optical switch inputs input light from the first port, and in the optical switch, when the optical switch branches and outputs the input light that has been input from the first port to the second port and the third port, a branching ratio between the second port and the third port being set such that return light at the same level as reflected light with respect to the input light received from the grating coupler is able to be obtained from the third port, and
in the phase shifter, an amount of phase shift of the return light transmitting to the third port is set in a direction in which the reflected light received from the grating coupler is canceled out.

3. The optical device according to claim 2, wherein
the optical device includes
an optical circuit chip including the optical circuit, and
a test circuit chip that is optically connected to the optical circuit chip, and
the test circuit chip includes
the grating coupler,
the phase shifter, and
the loop mirror.

4. The optical device according to claim 2, further including,
an optical attenuator that is arranged between the second port and the optical circuit, wherein
in the optical switch, the branching ratio between the second port and the third port is set such that the return light at the same level as the reflected light with respect to the input light received from the grating coupler is able to be obtained from the third port while controlling the optical attenuator such that the optical attenuator blocks the input light transmitting from the second port to the optical circuit, and
in the phase shifter, the amount of phase shift of the return light transmitting to the third port is set in the direction in which the reflected light received from the grating coupler is canceled out while controlling the optical attenuator such that the optical attenuator blocks the input light transmitting from the second port to the optical circuit.

5. The optical device according to claim 2, wherein the optical switch is configured by a 2×2 switch including two inputs having the first port and a fourth port, and two outputs having the second port and the third port.

6. The optical device according to claim 5, wherein the fourth port included in the optical switch is connected to an optical termination.

7. The optical device according to claim 6, wherein the optical termination includes an optical absorption member.

8. The optical device according to claim 6, wherein the optical termination is a photo detector.

9. A wafer comprising:
a plurality of optical chips, wherein
each of the optical chips includes
an optical circuit,
a grating coupler, and
an optical switch that includes
a first port that is connected to the grating coupler,
a second port that is connected to the optical circuit, and
a third port that is connected to a loop mirror by way of a phase shifter.

10. An optical transceiver comprising:
an optical device that is formed on a wafer and that includes an optical transmitter that transmits transmission light in accordance with an electrical signal; and
a signal processing unit that generates the electrical signal, wherein
the optical device includes
an optical circuit that includes the optical transmitter,
a grating coupler, and
an optical switch that includes
a first port that is connected to the grating coupler,
a second port that is connected to the optical circuit, and
a third port that is connected to a loop mirror by way of a phase shifter.

11. The optical transceiver according to claim 10, wherein the optical device includes an optical receiver that converts reception light to the electrical signal.
